(19) United States
(12) Patent Application Publication
(10) Pub. No.: US 2016/0165332 A1
(43) Pub. Date: Jun. 9, 2016

(54) Headset

(71) Applicant: Marcus LEWIS, Ross-on Wye, Herefordshire (GB)

(72) Inventor: Marcus Lewis, Ross-on-Wye, Herefordshire (GB)

(21) Appl. No.: 14/905,896

(22) PCT Filed: Jul. 17, 2014
(86) PCT No.: PCT/GB2014/052194

§ 371 Date: Jan. 18, 2016

(30) Foreign Application Priority Data
Jul. 19, 2013 (GB) 1312966.3

(51) Int. Cl. H04R 1/10; H04R 3/12

(52) U.S. Cl. CPC H04R 1/1033; H04R 3/12; H04R 1/1091; H04R 2201/109

(57) ABSTRACT

A headset comprises a pair of speakers physically interconnected with one another by a mechanical link, a wireless receiver device carried by the link and operable to output a respective signal for each of the speakers, and optical transmission means whereby each respective signal is transmitted to the associated speaker.

This invention relates to a headset, for example for use in listening to music or as a hands free device for use with a mobile communications telephone device or the like.

Headsets for use in listening to music, for example in conjunction with as suitable media data file player such as an mp3 or mp4 player, or from a radio, or for use as part of a hands free kit for use in conjunction with a mobile telephone or other communications device are in wide spread use.

The use of hands free kits to allow use of mobile telephone or other communications devices in a hands free manner, for example whilst driving a vehicle, is thought to enhance safety, and is a legal requirement in some countries if mobile communications devices are to be operated whilst driving. The use of headsets to listen to music enhances the clarity with which the music can be heard, and reduces the distraction or disturbance to others in the vicinity of the user by reducing ambient noise.

Traditionally, such headsets have been of cabled or wired form, including a cable or wire linking the source device, for example in the form of a mobile telephone or mp3 player, to one or more speakers located adjacent or in a user's ears (depending upon the type of speaker used). However, the presence of a cable or wire linking the headset to the source device can be inconvenient, for example becoming entangled or caught, resulting in the speakers being pulled out of the correct position relative to the user's ears. Such pulling may be annoying or painful. Furthermore, as the headsets are not designed to be operated by pulling on the associated cables, there is a risk of damage to the headset in such circumstances. Some users also consider the presence of the cables or wires to be unsightly. There has accordingly been a move towards the use of wireless transmission techniques in the transmission of signals between a source device and a headset.

The wireless transmission technique in most common usage in this type of application makes use of a relatively low power short wave or microwave communications link, often transmitted using a standard known as Bluetooth.

Whilst the use of Bluetooth transmissions or the like provide a good, reliable communications link, the use of microwave communications links close to a user's head, as is the case where a wireless earpiece is used, carries some safety concerns. In particular, some user's feel that the absorption of microwave transmissions, even in small amounts, should be avoided, arguing that close-range, electromagnetic frequencies, or EMFs, which are emitted from wireless devices, are detrimental to the human body's bioelectrical systems because they inhibit the body's natural energy flow which can lead to congestion which results in pain and other discomfort such as nausea. They further contend that when congested energy flow is not properly addressed, it can lead to health problems, ranging from weight gain to brain tumors.

It is an object of the invention to provide a headset in which shielding of such transmissions is improved, thereby mitigating at least some of the health or safety concerns. Whilst particularly applicable to headsets in which signals are transmitted wirelessly, it may also be applied to headsets connected by a wired link to a source.

According to the present invention there is provided a headset comprising a pair of speakers physically interconnected with one another by a mechanical link, means carried by the link and operable to output a respective signal for each of the speakers, and optical transmission means whereby each respective signal is transmitted to the associated speaker.

The means carried by the link may comprise a wireless receiver device operable to receive signals via a wireless communications link, for example from a source such as a mobile telephone device or mp3 player. However, the means carried by the link may comprise a cable providing a cabled link, in use, between the headset and the source.

It will be appreciated that by using an optical transmission means, the need to provide an electrically conducting link between the receiver and each speaker can be avoided. By avoiding the provision of such a metallic conductive link, the formation of a waveguide by which wireless signals can be conducted towards the user's ears is reduced or avoided. The health concerns associated with the use of a headset with a wireless transmission arrangement are thus reduced.

As the receiver is located upon the mechanical link, and the mechanical link may, in use, be positioned adjacent or against part of a user's body, for example adjacent or against his or her neck or head, it is desirable for the mechanical link to have a suitable shield associated therewith to shield the adjacent part of the user's body from the transmitted signals and thereby further reduce the safety concerns.

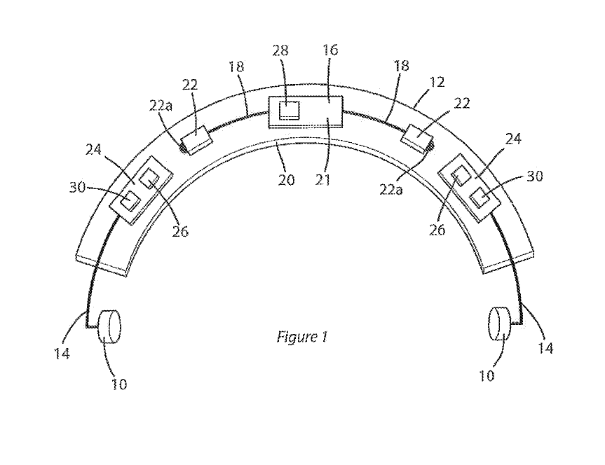

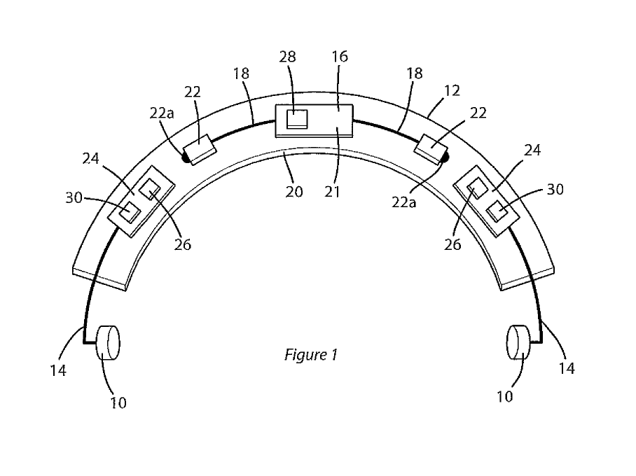

The invention will further be described, by way of example, with reverence to the accompanying drawing, FIG. 1, which is a diagrammatic view of a headset in accordance with an embodiment of the invention.

Referring to FIG. 1 a headset is illustrated which comprises a pair of speakers 10 secured to and interconnected by a mechanical link 12. In the arrangement illustrated, the mechanical link 12 takes the form of a flexible neckband intended to be worn behind a user's neck. The material of the neckband is conveniently selected to be flexible and comfortable to wear. It is envisaged that it will take a padded fabric form.

Whilst the illustrated arrangement involves the provision of a mechanical link 12 in the form of a neckband, the invention is not restricted in this regard. By way of example, the mechanical link 12 may be arranged to pass over a user's head, if desired. Furthermore, it could be of rigid, or part rigid form.

The speakers 10, in the arrangement illustrated, take the form of in-ear buds which a user inserts into his or her ears, in use, each speaker 10 including a thin electrical cable 14 by which the speaker 10 is connected to the mechanical link 12 and through which signals are transmitted, in use, to the associated speaker 10. It will be appreciated, however, that the invention is also applicable to other styles of headset and speaker, including speakers intended to be positioned over a user's ears, in use. In such an arrangement, the speakers may be secured directly to the mechanical link, for example by means of a joint allowing articulation of the speakers relative to the mechanical link.

Mounted upon part of the mechanical link 12 is a communications link receiver 16 adapted to receive signals transmitted thereto from a suitable source, for example in the form of an mp3 or mp4 media player, a mobile telephone device or the like. The receiver 16 conveniently takes the form of a stereo Bluetooth receiver arranged to receive signals from a stereo Bluetooth transmitter, to decode and split the received signals into respective audio signals for transmission to the associated speakers 10. The receiver 16 thus has two outputs 18, each associated with a respective one of the speakers 10.

At least the part of the mechanical link 12 upon which the receiver 16 is mounted, and conveniently all of the link 12, is provided with a layer 20 of an electromagnetic shielding material positioned between the receiver 16 and the adjacent part of the user's body, in use, so as to shield the adjacent part of the user's body from the signals being transmitted to the receiver 16. The layer 20 conveniently takes the form of a silver foil provided upon a polymer backing which coats the inner surface of the mechanical link 12. The silver foil is conveniently broken up into strips, for example 50 mm strips, the dimensions of which are chosen such that they are not multiples of the wavelength of the microwave Bluetooth transmission, and so do not form hot spots.

The ‘rear’ surface of the circuit board containing the antenna of the receiver 16 is conveniently provided with a further shielding layer 21.

If the outputs 18 were electrically connected to the speakers 10 by electrical conductors, than would be a risk that the conductors could serve as waveguides by which components of the transmitted communications signal could be conducted towards the user's ears. As there are concerns that the conduction of such signals towards (and into) the user's ear canal could have safety or health implications, in accordance with the invention the provision of an electrical connection between the receiver 16 and the speakers 10 is avoided. As a result, the presence of a waveguide assisting in the transmission of the signals in this manner is avoided.

In accordance with the invention, therefore, the outputs 18 of the receiver 16 are each connected to respective optical transmission means 22 carried by the mechanical link 12. Each optical transmission means 22 comprises a transmitter by which the signal carried by the associated output 18 is encoded to take the form of a digital signal to be transmitted as, for example, a suitably modulated square wave by appropriate control over the operation of a suitable LED 22a. It is envisaged that the square wave will have a frequency in the region of 80 kHz. The square wave may be generated using, for example, a NE555 timer or the like provided within the transmission means 22. It is envisaged that an LED 22a arranged to transmit light in the infrared part of the spectrum will be used, but this is just one option and other wavelengths or frequencies may be used without departing from the scope of the invention.

The optical or infrared signal transmitted by the transmission means 22 is received by a receiver means 24 spaced from the transmitter means 22 by a small distance. It is envisaged that the spacing between the transmitter means 22 and the associated receiver means 24 will be of the order of, say, one centimetre, but the invention is not restricted in this regard. Transmission over only a relatively short distance is thought to be advantageous in that it allows a relatively low power LED to be used, and as a result power consumption can be reduced and battery life can be extended.

The receiver means 24 takes the form of a suitable photodetector and decoder circuit operable to output the received signal, in demodulated and decoded form, stripping it from the square wave used in the transmission thereof, via the wires 14 to the associated speaker 10. Processing circuits 30, for example including a small amplifier, are conveniently included in the receiver means 24.

It will be appreciated that as each receiver means 24 is electrically isolated from the receiver 16 and transmitter means 22, the power requirements of each receiver means 24 must be met independently. As illustrated, therefore, each receiver means 24 includes its own battery 26 or other power supply, independent of the battery 28 used to operate the receiver 16 and transmitter means 24.

By ensuring that the receiver means 24, and speakers 10 are fully electrically isolated from the receiver 16, that there are no shared or common ground planes or the like and that they have separate power supplies, it will be appreciated that the formation of a waveguide by which signals car be carried to or towards the user's ear canals is avoided. Where the batteries 26, 28 are arranged to be recharged in situ, it is important to ensure that the circuitry used in the charging thereof does not contain any parts common to the charging of the various batteries.

Whilst the description hereinbefore is of an arrangement in which signals are transmitted to the headset via a wireless communications link, the invention is also applicable to headsets in which a wired link is provided between the headset and source. By way of example, the wired link may comprise a cable physically connected at one end to the mechanical link 12, the electrical conductors of the cable being connected to the outputs 18, or the outputs 18 being defined by the ends of the conductors, and the other ends of the conductors being connected to, for example, a 3.5 mm jack plug or other suitable connector for connection to an appropriate output socket of the source. The cable thus serves as a means connected to the link 12 and operable to output signals for each speaker.

The use of wired links, in general, runs the risk of microwaves being conducted to positions at or close to a users head, the wired link potentially serving as an antenna and conducting the received microwaves towards the users head. By the use of the invention, the speakers 10 are fully isolated from the cable, thus the risk of onward transmission of the microwaves is reduced.

It is envisaged that the transmitter means 22 and receiver means 21 can be located within a small housing, for example of diameter in the region of 25 mm and of thickness 5 mm, the housing serving as the mechanical link 12. In such an arrangement, the housing would have projecting therefrom the cable connecting the housing to the source, and cables 14 connecting the housing to the speakers 10. The lengths of the various cables may be chosen so as to allow the housing to sit, for example, at around the position of the users chest.

It will be appreciated that a wide range of modifications and alterations may be made to the arrangement described hereinbefore without departing from the scope of the invention as defined by the appended claims.

1. A headset comprising a pair of speakers physically interconnected with one another by a mechanical link, means carried by the link and operable to output a respective signal for each of the speakers, and optical transmission means whereby each respective signal is transmitted to the associated speaker.

2. The headset according to claim 1, wherein the means carried by the link comprises a wireless receiver device

3. The headset according to claim 2, wherein each speaker is electrically isolated from the wireless receiver device.

4. The headset according to claim 1, wherein the means carried by the link comprises a cable for connection to a source.

5. The headset according to claim 1, wherein the optical transmission means includes optical transmission means for transmission of signals to one of the speakers and independent optical transmission means for transmission of signals to the other of the speakers.

6. The headset according to claim 5, wherein each optical transmission means includes transmitter means and receiver means, the transmitter means and receiver means being carried by the mechanical link.

7. The headset according to claim 6, wherein the transmitter means comprises an infrared LED.

8. The headset according to claim 7, wherein the transmitter means is operable to transmit signals encoded onto a square wave.

9. The headset according to claim 1, further comprising shield means.

10. The headset according to claim 9, wherein the shield means includes a layer of shield material carried by the mechanical link.

11. The headset according to claim 9, wherein the shield means includes a shield layer provided upon a substrate carrying an antenna of the receiver.

12. The headset according to claim 1, wherein the link comprises a housing from which cables project and to which the speakers are connected.
